(19) United States
(12) Patent Application Publication
(10) Pub. No.: US 2007/0045426 A1
(43) Pub. Date: Mar. 1, 2007

(54) Memory card

(76) Inventors: Shigemasa Shiota, Tokyo (JP); Satoshi Yoshida, Tokyo (JP); Shigeo Kurakata, Tokyo (JP); Shinsuke Asari, Tokyo (JP); Tetsuya Iida, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/512,126

(22) Filed: Aug. 30, 2006

(30) Foreign Application Priority Data
Aug. 31, 2005 (JP) 2005-250676

(51) Int. Cl. G06K 19/06

(52) U.S. Cl. 235/492

(57) ABSTRACT

The present invention is directed to suppress propagation of noise from an interface controller to an IC card microcomputer. A memory card of the invention includes an external terminal, an IC card terminal, an interface controller connected to the external terminal, a memory device connected to the interface controller, and an IC card microcomputer connected to the interface controller. The interface controller controls operation of the memory device and the IC card microcomputer in response to an input from the external terminal. The IC card terminal is directly connected to a connection line between the interface controller and the IC card microcomputer. When operation of the IC card microcomputer responding to an input from the IC card terminal is permitted in parallel with operation responding to an input from the external terminal, the interface controller sets an output buffer in the interface controller connected to the connection line into a high impedance state.

### CROSS-REFERENCE TO RELATED APPLICATION

The present application claims priority from Japanese patent application No 2005-250676 filed on Aug. 31, 2005, the content of which is hereby incorporated by reference into this application.

### BACKGROUND OF THE INVENTION

The present invention relates to a memory card on which an IC card microcomputer is mounted together with a memory device.

International Publication No. 01/84490 (U.S. Pat. No. 6,669,487) describes a memory card on which an IC card microcomputer is mounted together with a memory device. The memory card has a memory card interface terminal in conformity with memory card standards such as a multimedia card and also an external interface terminal dedicated to the IC card microcomputer. A card host uses the memory card interface terminal for a memory operation of the memory card. For a security process by the IC card microcomputer, the external interface terminal dedicated to the IC card microcomputer is used.

Japanese Patent Publication No. 2005-84935 (US Publication No. 2005052924) also describes a memory card on which an IC card microcomputer is similarly mounted together with a memory device. In this memory card, a control using an external interface terminal dedicated to the IC card microcomputer and a control of the IC card microcomputer from a memory card interface terminal via an interface controller can be performed. In the control using the external interface terminal dedicated to the IC card microcomputer, although a communication protocol having high versatility such as SCI (Serial Communication Interface) which is employed by many IC card microcomputers can be used, but the host system need to have a time for data transferring by its slow transfer speed. In the case of controlling the IC card microcomputer from the memory card interface terminal via the interface controller, according to the interface specifications of the memory card, commands and data necessary for a data process are transferred at high speed and stored in a buffer, so that occupation time of the card host necessary for the transfer can be shortened. On the other hand, the interface controller has to perform protocol conversion between the memory card interface specifications and the interface specifications of the IC card microcomputer, so that development of circuits and software for the protocol conversion is required. When the interface control modes for the IC card microcomputer is selectable in accordance with requirement, it is convenient to increase flexibility in the functions of the card host and the uses of the memory card.

Because of the property of the selectable modes, the interface terminal of the IC card microcomputer and the external interface terminal dedicated to the IC card microcomputer are commonly connected to the interface controller. In the patent document 2, the IC card microcomputer is controlled by using the external interface terminal dedicated to the IC card microcomputer on precondition that supply of the operation power to the interface controller is stopped. In short, in a standby mode of the interface controller, direct control on the IC card microcomputer from the card host is permitted. However, when supply of the operation power to the interface controller is stopped, the state of the interface controller becomes indeterminate and there is the possibility that noise enters the IC card microcomputer. In the patent document 2, therefore, attention is paid to the above phenomenon. At the time of controlling the IC card microcomputer by using the external interface terminal dedicated to the IC card microcomputer, the operation power is supplied to an interface circuit part with the IC card microcomputer of the interface controller to fix the state of the interface circuit part of the interface controller to a desired state.

### SUMMARY OF THE INVENTION

The inventors herein have examined a memory card on which an IC card microcomputer is mounted together with a memory device. In the case where the IC card microcomputer is controlled directly from the card host in a low power consumption state (standby state) in which the interface controller is inoperable like in the patent document 2, the memory device cannot be accessed in parallel with the security process on the IC card microcomputer. In the case of improving the data process efficiency, it may be disturbed. To improve the data process efficiency, it is sufficient to control the IC card microcomputer directly from the card host in the state where the interface controller is operable (non-standby state). In this case, another means has to be provided to suppress propagation of noise from the interface controller to the IC card microcomputer, and suppress conflicts of signals which occur due to competition for a bus.

An object of the present invention is to provide a memory card in which propagation of noise from an interface controller to an IC card microcomputer can be suppressed when the IC card microcomputer can be controlled directly from a card host in a state where the interface controller is operable.

The above and other objects and novel features of the present invention will become apparent from the description of the specification and the appended drawings.

Outline of representative ones of inventions disclosed in the application will be briefly described as follows.

(1) Separation of IC Card Microcomputer

A memory card according to the invention includes: a first external interface terminal (3); a second external interface terminal (4); interface controllers (6, 6A, 6B) connected to the first external interface terminal; a memory device (7) connected to the interface controller; and an IC card microcomputer (8) connected to the interface controller. The interface controller controls operation of the memory device and the IC card microcomputer in response to an input from the first external interface terminal. The second external interface terminal has IC card terminals (4A, 4B, 4C) directly connected to a connection line 14 between the interface controller and the IC card microcomputer. When operation of the IC card microcomputer responding to an input from the IC card terminal is permitted in parallel with operation responding to an input from the first external interface terminal, the interface controller sets an output buffer in the interface controller connected to the connection line into a high impedance state.

With the above configuration, when the direct control on the IC card microcomputer in response to an input from the IC card terminal is permitted in a state where the interface controller can operate in response to an input from the first external interface terminal, propagation of noise from the interface controller to the IC card microcomputer can be suppressed.

(2) Separation of IC Card Microcomputer Using Control Terminal

A memory card according to the present invention has: a first external interface terminal (3); second external interface terminals (4, 5); an interface controller connected to the first external interface terminal; a memory device (7) connected to the interface controller; and an IC card microcomputer (8) connected to the interface controller. The interface controller controls operation of the memory device and the IC card microcomputer in response to an input from the first external interface terminal. The second external interface terminal has the IC card terminal (4A, 4B, 4c) directly connected to a connection line (14) between the interface controller and the IC card microcomputer and a control terminal 5. The interface controller sets output buffers (12oc, 12od, 12or) in the interface controller connected to the connection line into a high impedance state in response to a first state of the control terminal, and sets the output buffers to a state where output operation can be performed in response to a second state of the control terminal.

With the above configuration, the direct control on the IC card microcomputer from the IC card terminal is permitted in a state where the interface controller can operate in response to an instruction from the first external interface terminal. In particular, by setting the output buffer for the connection line into the high impedance state in response to the first state of the control terminal, propagation of noise from the interface controller to the IC card microcomputer can be suppressed.

As the first example of the invention, the IC card terminal includes a clock input/output terminal (4A) and a data input/output terminal (4c). The IC card microcomputer has a clock input buffer (8ic) connected to a line to which the clock input/output terminal is connected in the connection line. The interface controller has a clock input buffer (12ic) and a clock output buffer (12oc) connected to a line to which the clock input/output terminal is connected in the connection line. The clock output buffer is set to a high impedance state in response to the first state of the control terminal and is set to a state where output operation can be performed in response to the second state of the control terminal. In the above, at the time of controlling the IC card microcomputer via the interface controller, the interface controller supplies clocks to the IC card microcomputer. The card host connected to the second external interface terminal can monitor the state of the clock via the clock input/output terminal. On the basis of the monitoring result, the card host can detect that the operation of the IC card microcomputer by control of the interface controller is not performed. When the operation is detected, the card host can perform direct control on the IC card microcomputer without competition with the interface controller. At this time, the card host supplies the clocks to the IC card microcomputer. Therefore, at the time of switching between the state where the IC card microcomputer is controlled via the interface controller and the state where the IC card microcomputer is controlled directly from the second external interface terminal, both of the clock outputting operations have to be temporarily stopped so that clocks in both of the states do not conflict with each other.

As the second example of the present invention, the IC card terminal includes a clock input/output terminal (4A) and a data input terminal (4C). The IC card microcomputer has a clock input buffer (8ic) connected to a line to which the clock input terminal is connected in the connection line. The interface controller has a clock input buffer (12ic) connected to a line to which the clock input terminal is connected in the connection line. In this configuration, also at the time of controlling the IC card microcomputer via the interface controller and at the time of directly controlling the IC card microcomputer from the second external terminal, clocks are supplied from the second external interface terminal to the IC card microcomputer. Therefore, at the time of switching between the state where the IC card microcomputer is controlled via the interface controller and the state where the IC card microcomputer is controlled directly from the second external interface terminal, there is no possibility that clocks conflict with each other. It is unnecessary to temporarily stop the clock outputting operation at the time of the switching.

In this case, the interface controller may generate a response signal (SPRT-ACK) for setting a first response state in response to the first state of the control terminal and setting a second response state in response to the second state of the control terminal, set an output buffer to the connection line into a high impedance state in response to the first response state of the response signal, and set the output buffer into a state where output operation can be performed in response to the second response state of the response signal. With the configuration, the card host connected to the second external interface terminal does not have to detect the end of control on the IC card microcomputer by the interface controller to change the control terminal to the second state.

When an output terminal (5B) of the response signal is further provided as one of the second external interface terminal, the card host can easily obtain a timing at which the direct control on the IC card microcomputer can start.

As the third example of the present invention, the IC card terminal includes a clock input/output terminal (4A) and a data input/output terminal (4C). The IC card microcomputer has a clock input buffer (8ic) connected to a line to which the clock input/output terminal is connected in the connection line. The interface controller has a clock input buffer (12ic) and a clock output buffer (12oc) connected to a line to which the clock input/output terminal is connected in the connection line, and a phase compensating circuit (19). The phase compensating circuit performs phase compensating operation of adjusting the phase of a clock which is output from the clock output buffer to the phase of a clock which is input from the clock input buffer. The phase compensating circuit continues the phase compensating operation also in a high impedance state of the clock output buffer. In this configuration, the card host connected to the second external interface terminal has the phase compensating circuit for adjusting the phase of a clock output from the clock input/output terminal to the phase of a clock input from the clock input/output terminal. Consequently, the phase of a clock supplied from the second external interface terminal to the IC card microcomputer and that of a clock supplied from the interface controller to the IC card microcomputer are matched. Therefore, at the time of switching between the state where the IC card microcomputer is controlled via the interface controller and the state where the IC card microcomputer is directly controlled from the second external interface terminal, it is unnecessary to temporarily stop both of the clock outputting operations.

(3) Separation of IC Card Microcomputer Using Control Data

A memory card (1A) according to the present invention includes: a first external interface terminal; a second external interface terminal; an interface controller connected to the first external interface terminal; a memory device connected to the interface controller; and an IC card microcomputer connected to the interface controller. The interface controller controls operation of the memory device and the IC card microcomputer in response to an input from the first external interface terminal. The second external interface terminal has an IC card terminal directly connected to a connection line between the interface controller and the IC card microcomputer. The interface controller reads predetermined control data (SEP/CON) from the memory device in response to power-on, sets an output buffer in the interface controller connected to the connection line into a high impedance state in response to a first state of the control data, and sets the output buffer to a state where output operation can be performed in response to a second state of the control data.

With the above configuration, direct control on the IC card microcomputer from the IC card terminal is permitted in a state where the interface controller is operable in response to an instruction from the first external interface terminal. Particularly, by setting the output buffer for the connection line into the high impedance state in response to the first state of the control data, propagation of noise from the interface controller to the IC card microcomputer can be suppressed.

As the fourth example of the invention, the interface controller reads predetermined control data from the memory device in response to a reset instruction, sets the output buffer to the connection line into a high impedance state in response to the first state of the read control data, and sets the output buffer into a state where output operation can be performed in response to the second state of the control data. In such a manner, by rewriting control data and performing the resetting instruction, switch between the direct control on the IC card microcomputer and the control via the interface controller can be easily performed.

(4) Separation of IC Card Microcomputer Using Command

A memory card (1B) according to the present invention includes: a first external interface terminal; a second external interface terminal; an interface controller connected to the first external interface terminal; a memory device connected to the interface controller; and an IC card microcomputer connected to the interface controller. The interface controller controls operation of the memory device and the IC card microcomputer in response to an input from the first external interface terminal. The second external interface terminal has an IC card terminal directly connected to a connection line between the interface controller and the IC card microcomputer. The interface controller sets an output buffer in the interface controller connected to the connection line into a high impedance state in response to a first command supplied from the first external interface terminal, and sets the output buffer into a state where output operation can be performed in response to a second command supplied from the first external interface terminal.

With the above configuration, direct control on the IC card microcomputer from the IC card terminal is permitted in a state where the interface controller is operable in response to an instruction from the first external interface terminal. Particularly, by setting the output buffer for the connection line into the high impedance state in response to the first command of the control data, propagation of noise from the interface controller to the IC card microcomputer can be suppressed.

### BRIEF DESCRIPTION OF THE DRAWINGS

FIG. 1 is a block diagram illustrating a memory card in which indirect control and direct control on an IC card microcomputer can be switched by using a control terminal.

FIG. 2 is a logic circuit diagram showing a first example of a detailed interface form among a card host, an IC card microcomputer interface circuit, and an IC card microcomputer.

FIG. 3 is a timing chart showing operation of switching between the indirect control and the direct control on the IC card microcomputer in the configuration of FIG. 2.

FIG. 4 is a logic circuit diagram showing a second example of a detailed interface form among the card host, the IC card microcomputer interface circuit, and the IC card microcomputer.

FIG. 5 is a timing chart showing operation of switching between the indirect control and the direct control on the IC card microcomputer in the configuration of FIG. 4.

FIG. 6 is a logic circuit diagram showing a third example of a detailed interface form among the card host, the IC card microcomputer interface circuit, and the IC card microcomputer.

FIG. 7 is a timing chart showing operation of switching between the indirect control and the direct control on the IC card microcomputer in the configuration of FIG. 6.

FIG. 8 is a logic circuit diagram showing a fourth example of a detailed interface form among the card host, the IC card microcomputer interface circuit, and the IC card microcomputer.

FIG. 9 is a block diagram showing a memory card in which the indirect control and the direct control on the IC card microcomputer can be switched by using control data.

FIG. 10 is a logic circuit diagram showing an example of a detailed interface form among the card host, the IC card microcomputer interface circuit, and the IC card microcomputer in the configuration of FIG. 9.

FIG. 11 is a timing chart showing operation of switching between the indirect control and the direct control on the IC card microcomputer in the configuration of FIG. 10.

FIG. 12 is a block diagram showing a memory card in which the indirect control and the direct control on the IC card microcomputer can be switched by using a command.

FIG. 13 is a flowchart showing a control procedure of operation of switching between the indirect control and the direct control on the IC card microcomputer in the configuration of FIG. 12.

FIG. 14 is a block diagram of a memory card configured in consideration of low power consumption in operation of the direction control of the IC card microcomputer.

### DETAILED DESCRIPTION OF PREFERRED EMBODIMENTS

Separation of IC Card Microcomputer Using Control Terminal

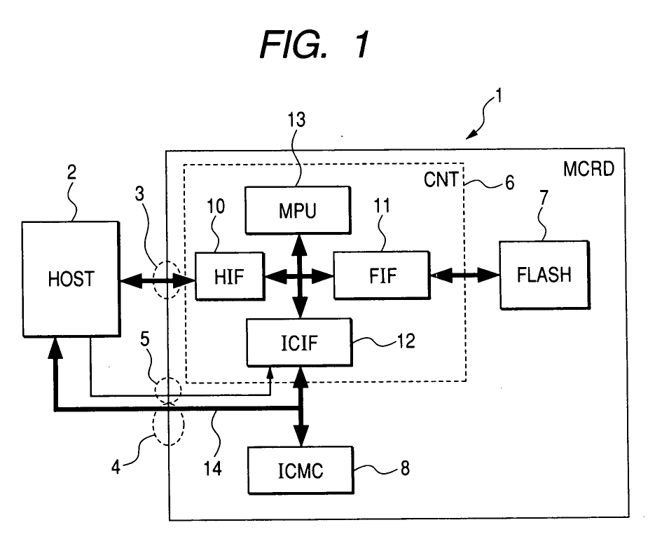

FIG. 1 illustrates a first example of a memory card according to the invention. Although not limited, a memory card 1 shown in the diagram has a configuration in conformity with the specifications of a MultiMedia Card (MultiMedia Card is a trademark of Infineon Technologies AG in Japan and will be abbreviated as “MMC” hereinbelow). The memory card 1 has not only a memory card function in conformity with the MMC but also a security process function. The memory card 1 is connected to a card host 2 such as a cellular phone, a portable information terminal (PDA), a personal computer, a music player (with/without recording function) device, a camera, a video camera, an automatic teller machine, a street-corner terminal, or a payment terminal.

The memory card (MCRD) 1 has an external terminal 3 as a first external interface terminal, an IC card terminal 4 and a control terminal 5 as second external interface terminals, an interface controller (CNT) 6, a flash memory (FLASH) 7 as a memory device, and an IC card microcomputer (ICMC) 8. Although not limited, the interface controller 6, flash memory 7, and IC card microcomputer 8 are constructed by separate semiconductor integrated circuit chips.

The interface controller 6 has a host interface circuit (HIF) 10, a flash interface circuit (FIF) 11, an IC card microcomputer interface circuit (ICIF) 12, and a microcomputer (MPU) 13 for control as a control circuit.

The external terminal 3 is in conformity with MMC interface specifications and includes a clock input terminal, a command input/output terminal, a data input/output terminal, a power supply terminal, and a ground terminal. The host interface circuit 10 is connected to the external terminal 3 and is in conformity with the MMC interface specifications, so that commands and data are input/output between the host interface circuit 10 and the card host 2.

The flash memory 7 is a memory chip using, as a memory medium, an electrically programmable nonvolatile semiconductor memory to/from which data can be read/written by a flash memory command. The flash memory 7 is connected to the flash interface circuit 11. In the case where a memory card command received by the host interface circuit 10 is a memory access command, the microcomputer 13 for control instructs the flash interface circuit 11 to read/write data from/to the flash memory 7 in accordance with a flash access control routine designated by the command code.

The IC card microcomputer 8 is a microcomputer chip which can be used also when it is embedded in a plastic board of an IC card. For example, an external terminal, an electric signal protocol, and commands of the IC card microcomputer 8 are in conformity with the ISO/IEC7816 standard. The IC card microcomputer 8 has, although not shown, for example, a CPU for performing computing process, a ROM (Read Only Memory) for storing data and a program, a RAM (Random Access Memory), an EEPROM (Electrically Erasable Programmable ROM), and a serial interface for transmitting/receiving data to/from the outside. The external terminal of the IC card microcomputer 8 is connected to the IC card microcomputer interface circuit 12 and also the IC card terminal 4. In the case where a memory card command received by the host interface circuit 10 is a command to write data to the IC card microcomputer 8, the microcomputer 13 for control instructs the IC card microcomputer interface circuit 12 to serially transfer IC card commands supplied as data of write commands to the IC card microcomputer 8 in accordance with a control routine designated by the memory card command. The IC card microcomputer 8 performs security process in response to the IC card command and sends back an IC card response (R-APDU) as a result of the security process to the IC card microcomputer interface circuit 12. The IC card response sent to the IC card microcomputer interface circuit 12 can be output from the host interface circuit 10 to the outside in response to a memory card command for reading data from the IC card.

The card host 2 can perform not only a control on the IC card microcomputer 8 via the interface controller 6 using the memory card command but also a directly control on the IC card microcomputer 8 from the IC card terminal 4. In the direct control using the IC card terminal 4, a communication protocol having high versatility such as SCI (Serial Communication Interface) which is employed by many IC card microcomputers 8 can be used, but transfer speed via the SCI interface is slower than that via the MMC interface. In the case of performing a control via the interface controller 6 using the memory card command, commands and data necessary for a data process are transferred at high speed and stored in a buffer (not shown) in accordance with the MMC interface specifications. In such a manner, occupation time of the card host necessary for the transfer can be shortened. On the other hand, the interface controller 6 has to perform protocol conversion between the MMC interface specifications and the interface specifications of the IC card microcomputer 8 by the IC card microcomputer interface circuit 12 and the like, and development of circuits and software for the protocol conversion is necessary. Since the interface control modes for the IC card microcomputer 8 is selectable in accordance with requirement, it is convenient to increase flexibility in the functions of the card host 2 and the uses of the memory card. In the case of enabling the IC card microcomputer 8 to be controlled directly from the card host 2, in parallel with the security process of the IC card microcomputer 8, an access to the flash memory 7 by the interface controller 6 is permitted. In short, when the IC card microcomputer 8 can be controlled directly from the IC card terminal 4, the interface controller 6 is also kept operable in response to a command input from the external terminal 3. When the IC card microcomputer 8 can be controlled directly from the IC card terminal 4, the interface controller 6 enters the state of the control terminal 5 and, in accordance with the instruction, an output buffer connected to the IC card microcomputer 8 is controlled to a high impedance state in accordance with the instruction. With the configuration, even when the direct control on the IC card microcomputer 8 by the IC card terminal 4 is permitted in the state where the interface controller 6 is operable in response to the instruction from the external terminal 3, propagation of noise from the interface controller 6 to the IC card microcomputer 8 can be suppressed. The details of the control on the IC card microcomputer interface circuit 12 at the time of the direct control of the IC card microcomputer 8 will be described below.

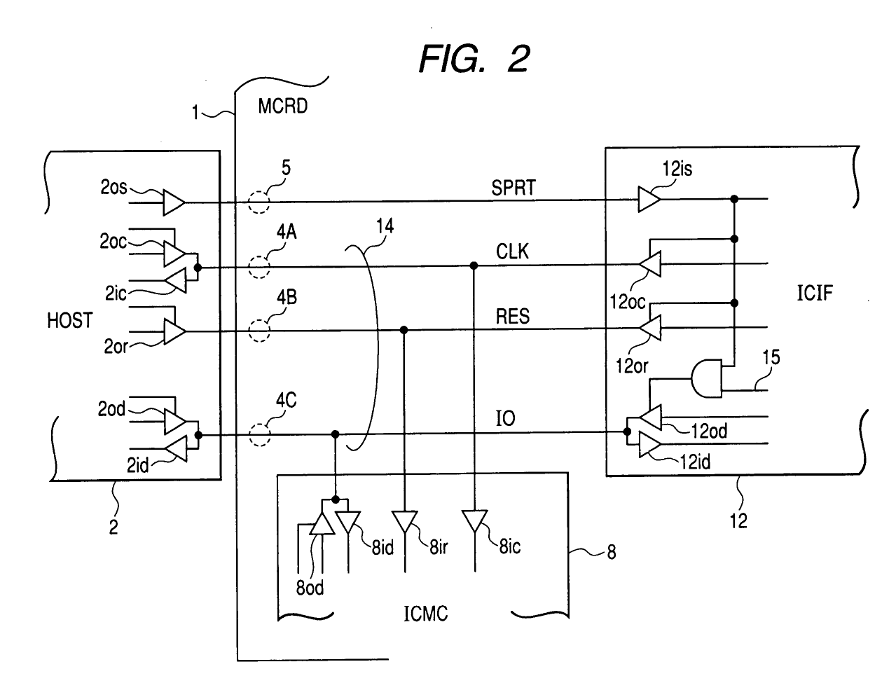

FIG. 2 shows a first example of a detailed interface mode among the card host 2, the IC card microcomputer interface circuit 12, and the IC card microcomputer 8. The IC card terminal 4 is in conformity with, for example, the IC card external interface specifications of ISO/IEC7816 and has, for example, a clock terminal (CLK) 4A, a reset terminal (RES) 4B, an input/output terminal (IO) 4C, and not-shown power supply terminal and ground terminal. The IC card terminals 4 are connected to corresponding terminals of the IC card microcomputer interface circuit 12 and the IC card microcomputer 8 via a connection line 14. The control terminal 5 receives a separate signal SPRT from the card host 2 and supplies it to the IC card microcomputer interface circuit 12.

The card host 2 has an output buffer 2os of the separate signal SPRT, a clock input buffer 2ic, a clock output buffer 2oc, a reset signal output buffer 2or, a data input buffer 2id, and a data output buffer 2od. The IC card microcomputer 8 has a clock input buffer 81c, a reset signal input buffer 8ir, a data input buffer 81d, and a data output buffer 8od. The IC card microcomputer interface circuit 12 has a separate signal input buffer 12is, a clock output buffer 12oc, a reset signal output buffer 12or, a data input buffer 12id, and a data output buffer 12od. All of the output buffers 2oc, 2or, 2od, 8od, 12oc, 12or, and 12od are tristate output buffers and selectively enter a high impedance state. The output buffers 12oc, 12or, and 12od of the IC card microcomputer interface circuit 12 have a high impedance state on the basis of the low level of the separate signal SPRT. A signal 15 is a tristate control signal in the IC card microcomputer interface circuit 12, which is a signal instructing an output operation by its high level. The data output buffer 12od is tristate-controlled by an AND signal between the signal 15 and the separate signal SPRT. The output buffers 12oc and 12or are tristate-controlled only by the separate signal SPRT.

In FIG. 2, at the time of controlling the IC card microcomputer 8 via the IC card microcomputer interface circuit 12, the separate signal SPRT is set to the high level so that the output buffers 12oc, 12or, and 12od can perform output operation. To the IC card microcomputer 8, clocks are supplied from the output buffer 12oc. The card host 2 can monitor the state of the clock from the clock terminal 4A. By stop of the clock being monitored, the card host 2 can detect that the control on the IC card microcomputer 8 by the interface controller 6 is not performed. On detection of the state, the card host 2 sets the separate signal SPRT to the low level, thereby enabling the direct control on the IC card microcomputer 8 to be performed without competing with the interface controller 6. At this time, the card host 2 supplies the clock CLK to the IC card microcomputer 8 via the terminal 4A.

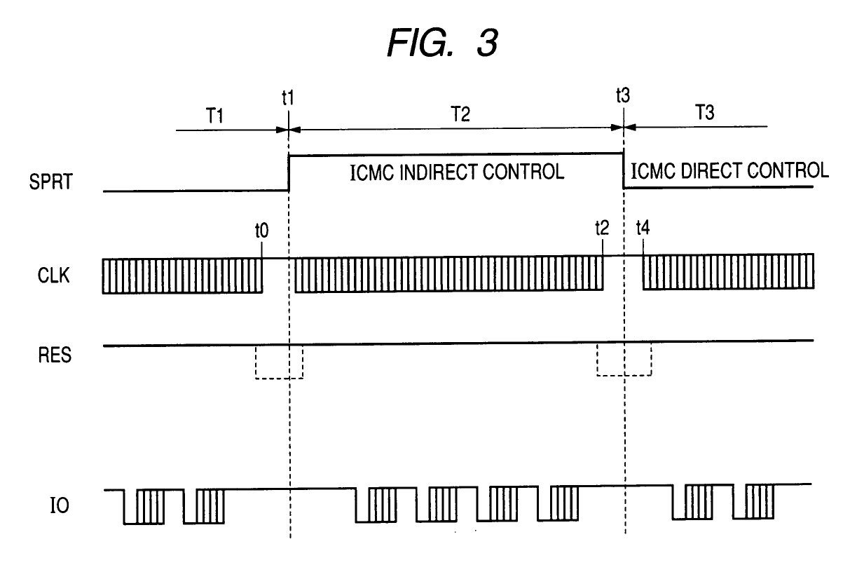

FIG. 3 shows the operation timings at that time. In the periods of T1 and T3, the card host 2 directly controls the IC card microcomputer 8 from the IC card terminal 4 (the direct control on the IC card microcomputer). In the period of T2, the IC card microcomputer 8 is controlled via the interface controller 6 (the indirect control on the IC card microcomputer). When the state of T1 is changed to the state of T2, the card host 2 stops outputting of the clock CLK (time t0) and, after that, sets the separate signal SPRT to the high level. Synchronously, the clock buffer 12oc of the IC card microcomputer interface circuit 12 starts outputting the clock CLK from the time t1. When the state of T2 is changed to the state of T3, the IC card microcomputer interface circuit 12 stops outputting of the clock CLK (time t2). On detection of the stop, the card host 2 inverts the separate signal SPRT to the low level (time t3) and, after that, the block buffer 2oc of the card host 2 starts outputting the clock CLK (time t4). As necessary, a circuit which generates the clock signal CLK may give a reset instruction with a reset signal RES.

Although dynamic switching is shown in the embodiment, the card host may set the SPRT signal to the low or high level before turn-on of the card power supply, and statically control connection/disconnection of the IC card microcomputer.

In the configuration of FIG. 2, at the time of switching between the state where the IC card microcomputer 8 is controlled via the interface controller 6 and the state where the IC card microcomputer 8 is directly controlled by the IC card terminal 4, both of the clock outputting operations have to be stopped temporarily so that clocks from both sides do not conflict with each other.

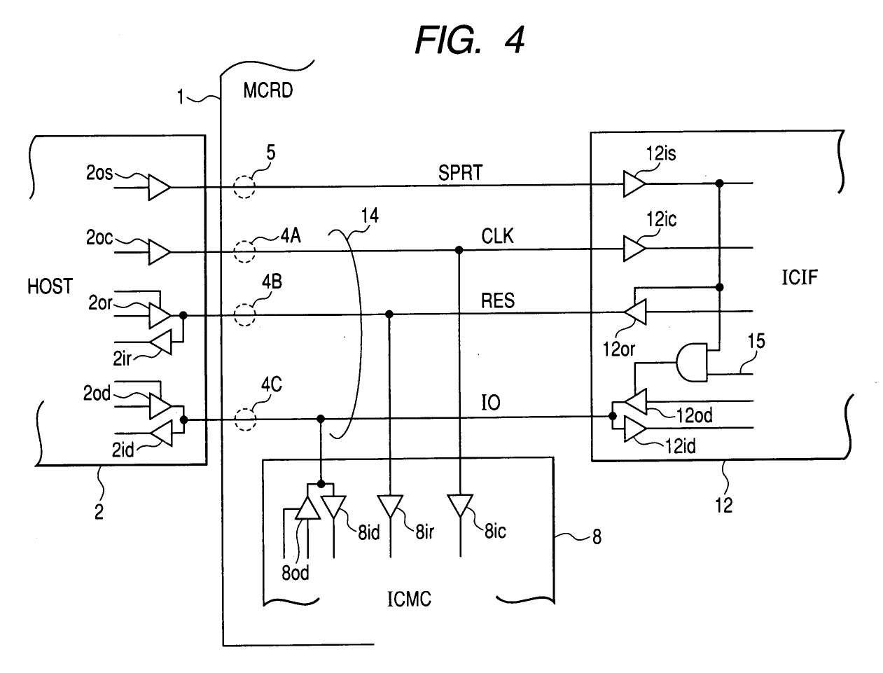

FIG. 4 shows a second example of a detailed interface form among the card host 2, the IC card microcomputer interface circuit 12, and the IC card microcomputer 8. The card host 2 has the output buffer 2os of the separate signal SPRT, the clock output buffer 2oc, the reset signal output buffer 2or, a reset signal input buffer 2ir, the data input buffer 2id, and the data output buffer 2od. The IC card microcomputer 8 is the same as that in FIG. 2. The IC card microcomputer interface circuit 12 has the separate signal input buffer 12is, a clock input buffer 12ic, the reset signal output buffer 12or, the data input buffer 12id, and the data output buffer 12od. The point different from FIG. 2 is that the card host 2 supplies the clock signal CLK to both of the IC card microcomputer interface circuit 12 and the IC card microcomputer 8. The output buffers 12ic, 12or, and 12od of the IC card microcomputer interface circuit 12 have a high impedance in response to the low level of the separate signal SPRT in a manner similar to the above.

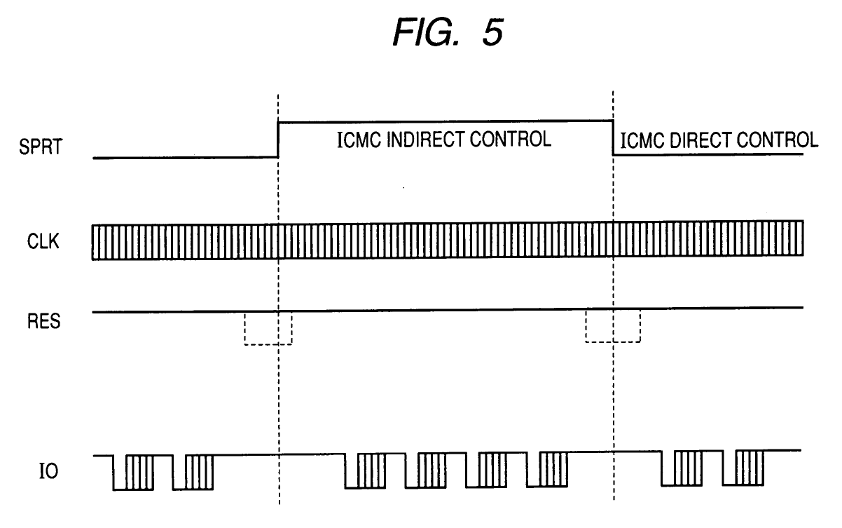

In the configuration, at the time of controlling the IC card microcomputer 8 via the interface controller 6 and also at the time of directly controlling the IC card microcomputer 8 from the IC card terminal 4, the clock is supplied from the clock terminal 4A for the IC card to the IC card microcomputer 8. Therefore, as shown in FIG. 5, at the time of switching between the state where the IC card microcomputer 8 is controlled via the interface controller 6 and the state of directly controlling the IC card microcomputer 8 from the IC card terminal 4, there is no possibility that the clock signals CLK conflict with each other, and it is not necessary to temporarily stop the clock outputting operation at the time of switch.

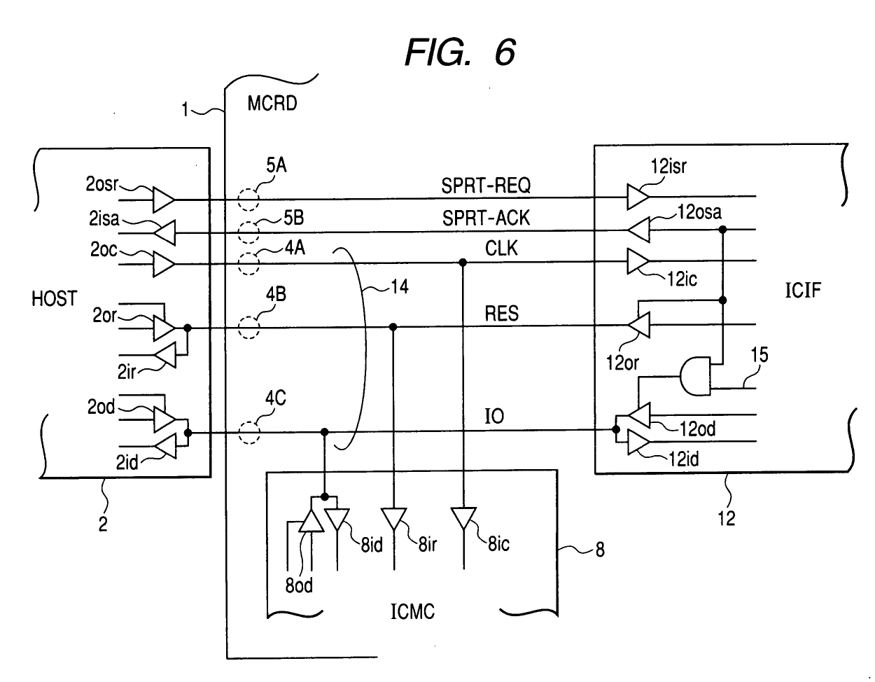

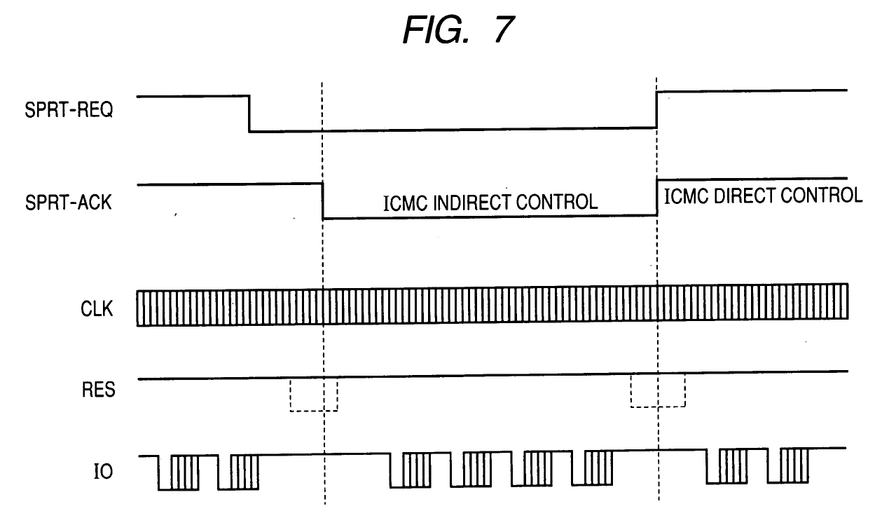

FIG. 6 shows a third example of a detailed interface form among the card host 2, the IC card microcomputer interface circuit 12, and the IC card microcomputer 8. The point different from FIG. 4 is that, in place of the input terminal 5 of the separate signal SPRT, an input terminal 5A of a separate request signal SPRT-REQ and an output terminal 5B of a separate acknowledge signal SPRT-ACK are employed. The card host 2 outputs the separate request signal SPRT-REQ. The IC card microcomputer interface circuit 8 has an input buffer 8isr for the separate request signal SPRT-REQ. When the low level of the separate request signal SPRT-REQ is recognized by an internal circuit (not shown) and the IC card microcomputer interface circuit 12 is not controlling the IC card microcomputer 8 or, if the IC card microcomputer interface circuit 12 is controlling the IC card microcomputer 8, when the control is finished, in response to it, the separate acknowledge signal SPRT-ACK is set to the low level and is output from an output buffer 12osa. The reset output buffer 12or and the data output buffer 12od are tristate-controlled by the separate acknowledge signal SPRT-ACK. When the separate acknowledge signal SPRT-ACK is set to the low level, the reset output buffer 12or and the data output buffer 12od are controlled to have a high impedance state. FIG. 7 shows operation timings of switching between the indirect control and the direct control of the IC card microcomputer 8. In a manner similar to FIG. 5, it is unnecessary to stop the clock signal CLK at the time of switching. In the third example, when the card host 2 requests the direct control by the separate request signal SPRT-REQ, it is unnecessary to detect end of the indirect control on the IC card microcomputer 8 by the interface controller 6. When the IC card microcomputer interface circuit 12 itself does not determined the end, the control of making the output buffer to have a high impedance is not performed. In particular, the IC card microcomputer interface circuit 12 generates the acknowledge signal SPRT-ACK and outputs it to the card host 2, so that the card host 2 can easily obtain the timing at which the direct control on the IC card microcomputer 8 can start.

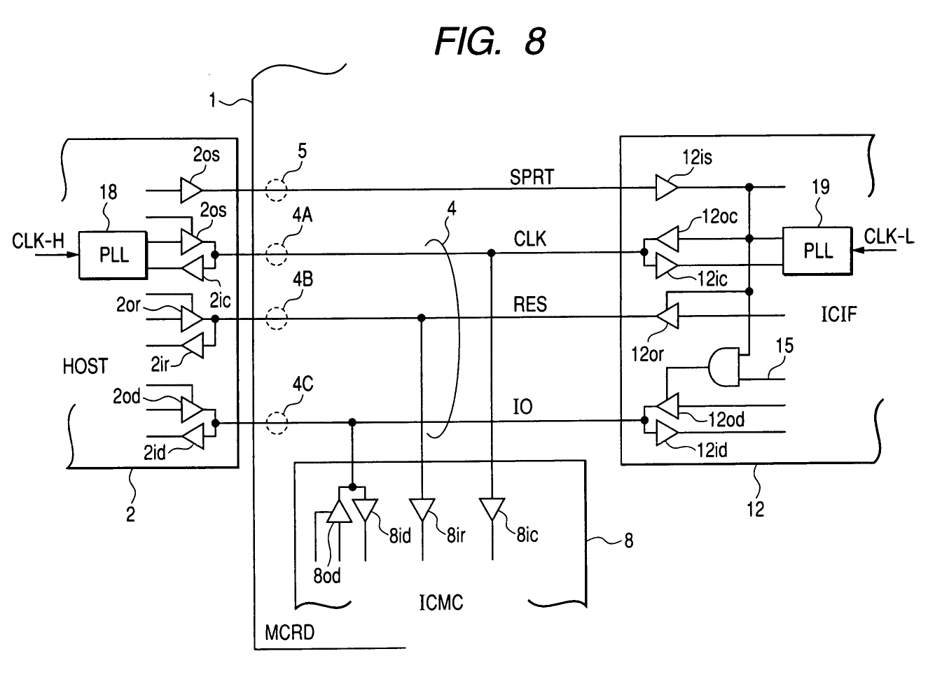

FIG. 8 shows a fourth example showing a detailed interface form among the card host 2, the IC card microcomputer interface circuit 12, and the IC card microcomputer 8. Also in the example of FIG. 8, in a manner similar to FIG. 2, when the card host 2 directly controls the IC card microcomputer 8, the card host 2 outputs a clock signal. When the IC card microcomputer 8 is indirectly controlled by the IC card microcomputer interface circuit 12, the IC card microcomputer interface circuit 12 outputs the clock signal CLK. The point different from FIG. 2 is that the card host 2 and the IC card microcomputer interface circuit 12 have PLL circuits 18 and 19, respectively, as phase compensating circuits.

When the clock output buffer 2oc is controlled in a high impedance state, the PLL circuit 18 receives the clock signal CLK from the input buffer 2ic and generates a synchronized clock signal having the same frequency and phase as those of the clock signal CLK on the basis of an internal clock signal CLK-H. The clock signal CLK input to the input buffer 2ic is a clock signal which is output from the IC card microcomputer interface circuit 12 when the IC card microcomputer 8 is indirectly controlled. Therefore, when the separate signal SPRT is set to the low level and the indirect control of the IC card microcomputer 8 changes to the direct control, the card host 2 does not have to consider the timing of changing the output buffer 2oc from the high impedance state to the output operation state together with output of the low level of the separate signal SPRT, the phase and the waveform of the clock signal CLK are hardly disturbed at the time of switching the source of generating the clock signal CLK. This is because the phase and frequency of the clock signal to be output from the clock output buffer 2oc are preliminarily set to be the same as those of the clock signal output from the clock output buffer 12oc.

Similarly, when the clock output buffer 12oc is controlled in a high impedance state, the PLL circuit 19 receives the clock signal CLK from the input buffer 12ic and generates a synchronized clock signal having the same frequency and phase as those of the clock signal CLK on the basis of an internal clock signal CLK-I. The clock signal CLK input to the input buffer 12ic is a clock signal which is output from the card host 2 when the IC card microcomputer 8 is directly controlled. Therefore, when the separate signal SPRT is set to the high level and the direct control by the card host 2 changes to the indirect control via the IC card microcomputer interface circuit 12, it is unnecessary for the card host 2 to temporarily stop the operation of outputting the clock signal CLK. Without consideration of the timing of setting the separate signal SPRT to the high level to change the output buffer 12oc from the high impedance state to the output operation state, the phase and the waveform of the clock signal CLK are hardly disturbed at the time of switching the source of generating the clock signal CLK. This is because the phase and frequency of the clock signal to be output from the clock output buffer 12oc are preliminarily set to be the same as those of the clock signal output from the clock output buffer 2oc.

Consequently, at the time of switching between the state of controlling the IC card microcomputer 8 via the IC card microcomputer interface circuit 12 and the state of directly controlling the IC card microcomputer 8 from the IC card terminal 4, it is unnecessary to temporarily stop both of the clock outputting operations. Since the operation timing of switching between the indirect control and the direct control of the IC card microcomputer 8 is the same as that of FIG. 5, it is not shown.

Separation of IC Card Microcomputer Using Control Data

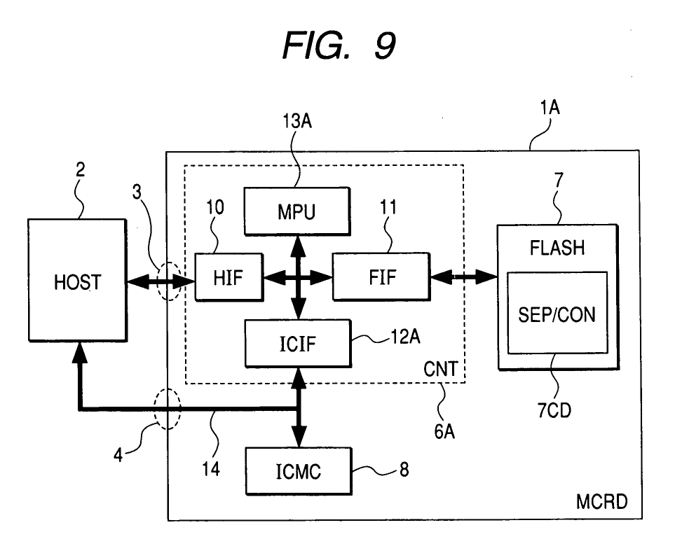

FIG. 9 shows another example of the memory card according to the present invention. In the above description, the control terminal 5 is used to control the tristate buffer in the IC card microcomputer interface circuit 12. A memory card 1A shown in FIG. 9 uses control data held in the flash memory 7 to control such a tristate buffer. Therefore, only the IC card terminal 4 is provided as the second external interface terminal but the control terminal 5 is not provided. As control data, separation selection parameters (SEP/CON) of the IC card microcomputer 8 are stored in a predetermined region 7CD in the flash memory 7.

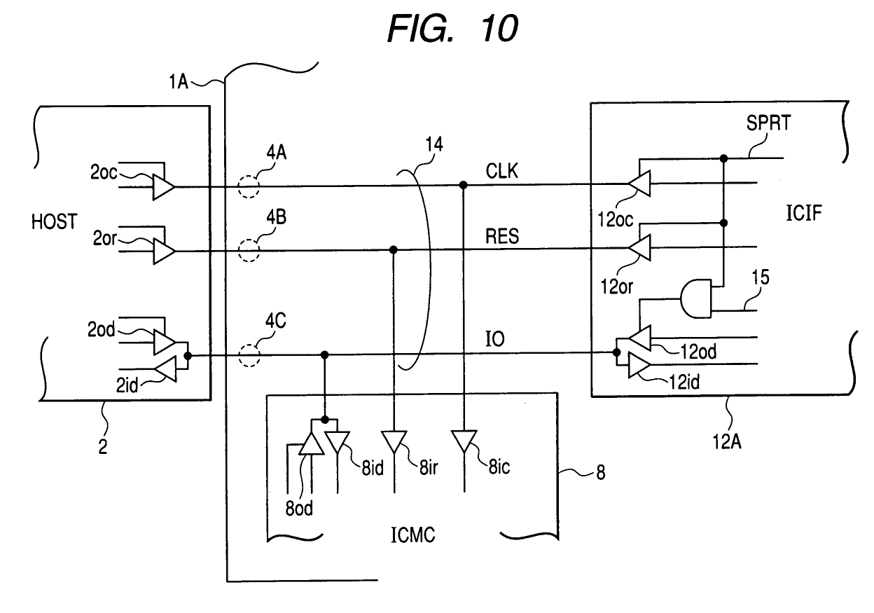

FIG. 10 shows an example of a detailed interface form among the card host 2, the IC card microcomputer interface circuit 12A, and the IC card microcomputer 8. In the indirect control of the IC card microcomputer 8, the clock signal CLK is output from the clock output buffer 12oc of the IC card microcomputer interface circuit 12A. In the direct control via the IC card terminal 4, the clock signal CLK is supplied from the card host 2.

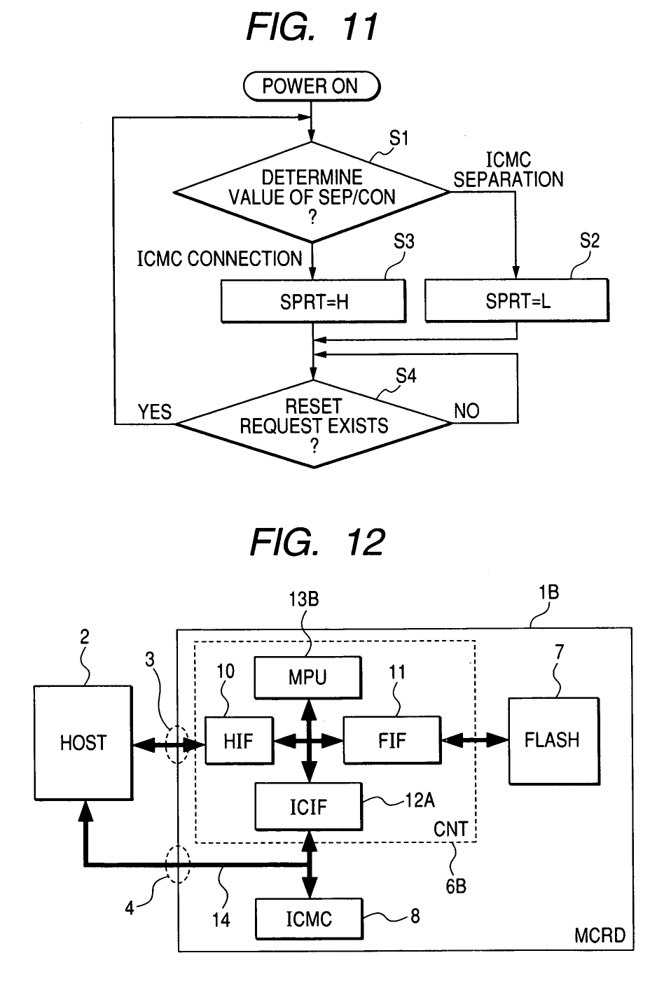

FIG. 11 shows a high-impedance control flow of the output buffer by the separation selection parameters (SEP/CON). A control microcomputer 13A reads the separation selection parameter (SEP/CON) from the predetermined region 7CD in the flash memory 7 in response to power-on of the memory card 1A or a specific command specifying a process of initializing a memory card or a resetting process, such as CMD0 and CMD1 in an MMC or CMD0 or ACMD41 in an SD card, and generates the separate signal SPRT in accordance with the value of the read separation selection parameter (SEP/CON) (S1). When the value of the separation selection parameter (SEP/CON) is the logical value 0, the separate signal SPRT is set to the low level (S2) and the output buffers 12oc, 12or, and 12od are set to the high impedance state. When the value of the separation/selection parameter (SEP/CON) is the logical value 1, the separate signal SPRT is set to the high level (S3) so that the output buffers 12oc, 12or, and 12od can perform outputting operation. Consequently, in a state where the interface controller 6A can operate in response to a memory command from the external terminal 3, the direct control on the IC card microcomputer 8 from the IC card terminal 4 is permitted. In particular, by setting the output buffers 12oc, 12or, and 12od of the IC card microcomputer interface circuit 12A to a high impedance state in response to the logical value 0 of the read separation selection parameter (SEP/CON), propagation of noise from the IC card microcomputer interface circuit 12A to the IC card microcomputer 8 can be suppressed.

The microcomputer 13A determines the presence/absence of the reset instruction from the card host 2 (S4). When there is a reset instruction, the microcomputer 13A returns to step S1 and repeats the process of setting the separate signal SPRT with reference to the separation selection parameter (SEP/CON). By rewriting the separation selection parameter (SEP/CON) and giving the resetting instruction, switch between the direct control on the IC card microcomputer 8 and the indirect control via the interface controller 6A can be easily performed.

Separation of IC Card Microcomputer Using Command

FIG. 12 shows further another example of the memory card according to the present invention. A specific command is used to control a tristate buffer in an IC card microcomputer interface circuit 12B. A control microcomputer 13B in an interface controller 6B recognizes the specific command and controls the tristate buffer. The interface form among the card host 2, the IC card microcomputer interface circuit 12A, and the IC card microcomputer 8 is the same as that in FIG. 10. The point different from the example of FIG. 11 is as follows. In FIG. 11, the direct control or the indirect control on the IC card microcomputer 8 is selected in accordance with the command for performing an initializing process or resetting process of the whole memory card 1A. In the example of FIG. 12, the direct control and the indirect control are switched in accordance with a command which can be generated at an arbitrary timing.

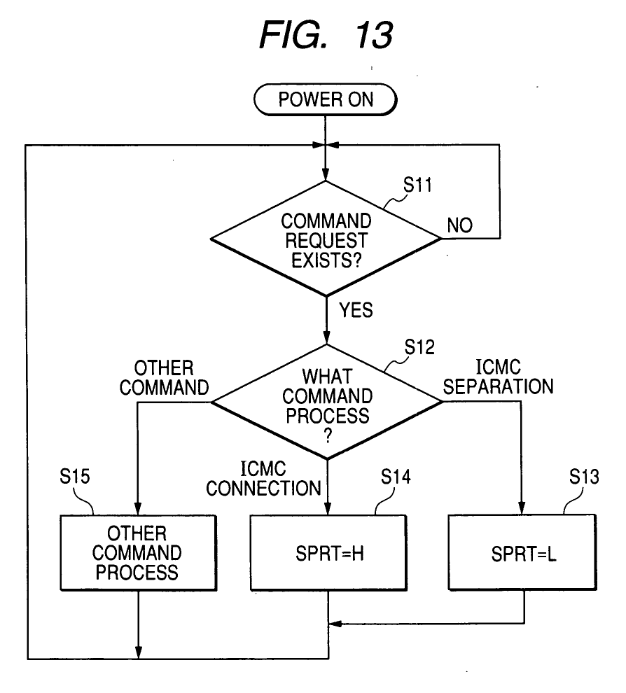

FIG. 13 shows a procedure of controlling the tristate buffer by the control microcomputer 13B. When a command is supplied to the host interface circuit 10 via the external terminal 3, the host interface circuit 10 sends an interruption request to the microcomputer 13B. On reception of the interruption request (S11), the control microcomputer 13B branches the command to a corresponding command process by using the command code of the command as a vector (S12). In a command process responding to a first command, the separate signal SPRT is set to the low level (S13), and the output buffers 12oc, 12or, and 12od are set to the high impedance state. In a command process responding to a second command, the separate signal SPRT is set to the high level (S14) to set a state where the output buffers 12oc, 12or, and 12od can perform outputting operation. For the other commands, command processes peculiar to the respective commands are performed (S15). Since the output buffer in the IC card microcomputer interface circuit 12A is set to a high impedance state in response to the first command, propagation of noise from the IC card microcomputer interface circuit 12A to the IC card microcomputer 8 can be suppressed at the time of direct control on the IC card microcomputer 8 from the IC card terminal 4.

Low Power Consumption in Operation of Direct Control on IC Card Microcomputer

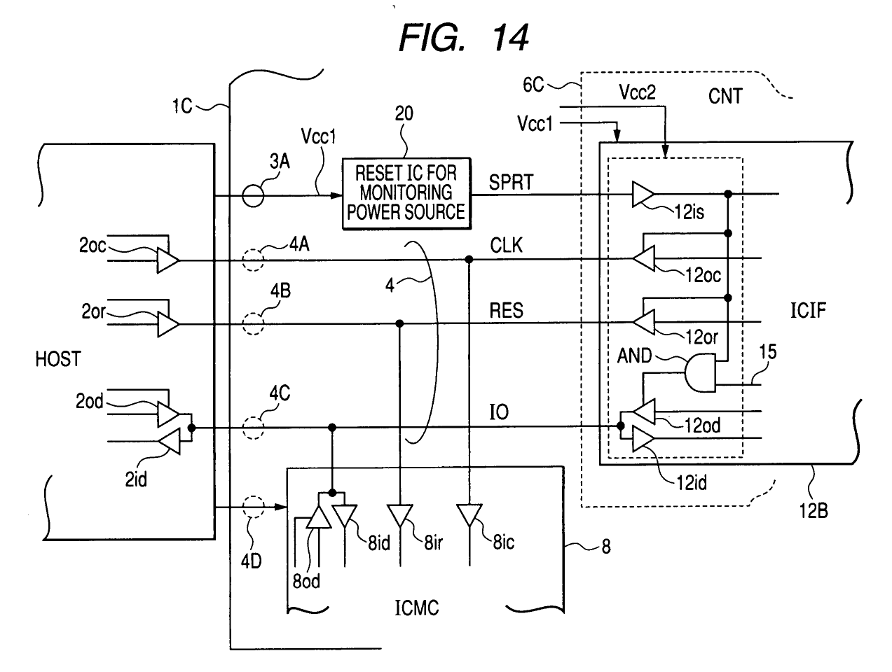

FIG. 14 shows further another example of the memory card according to the present invention. The separate signal SPRT is used in a manner similar to FIG. 2, and a reset IC 20 for monitoring power source is used to control the level of the separate signal SPRT. In the diagram, an operation power source Vcc1 of an interface controller 6C and an operation power source Vcc2 of the IC card microcomputer 8 are shown. Vcc1 is input from a terminal 3A as one of the external terminals 3. Vcc2 is supplied from a terminal 4D as one of the IC card terminals 4. In particular, the buffers 12is, 12oc, 12or, 12od, and 12id and the AND gate AND included in the IC card microcomputer interface 12B use Vcc2 as an operation power source. When the power source voltage Vcc1 becomes lower than operation permissible voltage, the reset IC 20 for monitoring power source sets the separate signal SPRT to the low level and controls the output buffers 12o, 12or, and 12od to have a high impedance state. When the power source voltage Vcc1 exceeds the operation permissible voltage, the separate signal SPRT is set to the high level and the output buffers 12o, 12or, and 12od are allowed to perform the outputting operation.

Consequently, even when supply of the power source Vcc1 is stopped in the case of directly controlling the IC card microcomputer 8 from the IC card terminal 4, the operations of the output buffers 12oc, 12or, and 12od are assured by the power source Vcc2. Therefore, while suppressing undesired noise propagation from the IC card microcomputer interface circuit 12B to the IC card microcomputer 8, lower power consumption can be realized. The configuration of FIG. 14 can be also employed together with the other configurations.

Although the present invention achieved by the inventors herein has been described substantially on the basis of the embodiments, the present invention is not limited to a memory device using a flash memory. The invention can be also applied to a volatile memory such as a DRAM or an SRAM, a nonvolatile memory such as an EPROM, EEPROM, or flash memory, a magnetic memory medium for use in an HDD and an MRAM, a phase change memory device for use in a DVD, and the like. The memory card specification is not limited to the multimedia card standard but the memory card may be in conformity with other memory card specifications such as an SD card standard. The multimedia card standard includes (1) multimedia card system specification version 3.3 and (2) multimedia card system specification version 4.0. The SD card standard includes (3) SD memory card specification Version 1.01 and (4) SD memory card specification version 1.1.

Although the memory card in conformity with the multimedia card standard has been described above as the embodiment, an input/output device on which an IC card microcomputer is mounted may be also employed. For example, in the case of performing data communication by using a radio communication apparatus from the card host 2 in a semiconductor device having the radio communication apparatus in place of the memory card, the present invention can be properly executed according to which one of the radio communication apparatus or the card host 2 controls the IC card microcomputer. In the case of decoding encoded data or encoding data by using the IC card microcomputer 8, either a control of preliminarily encoding data or decoding the data after communication under control of the card host 2, or a control of sequentially encoding or decoding data to be transmitted/received under control of the IC card microcomputer interface circuit of a radio communication apparatus can be selected.

Preferably, the IC card microcomputer uses a product certified by an evaluation/certification authority of ISO/IEC15408 as an international standard of security evaluation. Generally, in the case of using an IC card having the function of performing the security process in an actual electronic funds transfer service or the like, the IC card has to be evaluated and certified by the evaluation/certification authority of ISO/IEC15408. In the case of realizing a memory card by adding the security function to an MMC and using the memory card for actual electronic funds transfer service or the like, the memory card has to be similarly evaluated and certified by the evaluation/certification authority of ISO/IEC15408. The memory card of the invention obtains the security process function by having therein an IC card microcomputer certified by the evaluation/certification authority and performing the security process by using the IC card microcomputer. Therefore, the memory card of the invention can easily satisfy the security evaluation standard based on the ISO/IEC15408, and the development period for adding the security process function to an MMC can be shortened. The present invention, however, does not exclude an IC card chip which is not a product certified by an evaluation/certification authority of ISO/IEC15408 but may use an IC card chip according to the degree of security demanded by service provided by an IC card chip.

What is claimed is:

1. A memory card comprising:
a first external interface terminal;
a second external interface terminal;
an interface controller connected to the first external interface terminal;
a memory device connected to the interface controller; and
an IC card microcomputer connected to the interface controller,
wherein the interface controller controls operation of the memory device and the IC card microcomputer in response to an input from the first external interface terminal,
wherein the second external interface terminal has an IC card terminal directly coupled to a connection line between the interface controller and the IC card microcomputer and
wherein, when operation of the IC card microcomputer responding to an input from the IC card terminal is permitted in parallel with operation responding to an input from the first external interface terminal, the interface controller sets an output buffer in the interface controller connected to the connection line into a high impedance state.

2. A memory card comprising:
a first external interface terminal;
a second external interface terminal;
an interface controller connected to the first external interface terminal;
a memory device connected to the interface controller; and
an IC card microcomputer connected to the interface controller,
wherein the interface controller controls operation of the memory device and the IC card microcomputer in response to an input from the first external interface terminal,
wherein the second external interface terminal has an IC card terminal directly coupled to a connection line between the interface controller and the IC card microcomputer and a control terminal, and
wherein the interface controller sets an output buffer in the interface controller connected to the connection line into a high impedance state in response to a first state of the control terminal, and sets the output buffer to a state where output operation can be performed in response to a second state of the control terminal.

3. The memory card according to claim 2,
wherein the IC card terminal includes a clock input/output terminal and a data input/output terminal,
wherein the IC card microcomputer has a clock input buffer connected to a line to which the clock input/output terminal is connected in the connection line,
wherein the interface controller has a clock input buffer and a clock output buffer connected to a line to which the clock input/output terminal is connected in the connection line, and
wherein the clock output buffer is set to a high impedance state in response to the first state of the control terminal and is set to a state where output operation can be performed in response to the second state of the control terminal.

4. The memory card according to claim 2,
wherein the IC card terminal includes a clock input/output terminal and a data input terminal,
wherein the IC card microcomputer has a clock input buffer connected to a line to which the clock input terminal is connected in the connection line, and
wherein the interface controller has a clock input buffer connected to a line to which the clock input terminal is connected in the connection line.

5. The memory card according to claim 4, wherein the interface controller generates a response signal for setting a first response state in response to the first state of the control terminal and setting a second response state in response to the second state of the control terminal, sets an output buffer to the connection line into a high impedance state in response to the first response state of the response signal, and sets the output buffer into a state where output operation can be performed in response to the second response state of the response signal.

6. The memory card according to claim 5, wherein the second external interface terminal has an output terminal of the response signal.

7. The memory card according to claim 2,
wherein the IC card terminal includes a clock input/output terminal and a data input/output terminal,
wherein the IC card microcomputer has a clock input buffer connected to a line to which the clock input/output terminal is connected in the connection line,
wherein the interface controller has a clock input buffer and a clock output buffer connected to a line to which the clock input/output terminal is connected in the connection line, and a phase compensating circuit,
wherein the phase compensating circuit performs phase compensating operation of adjusting the phase of a clock which is output from the clock output buffer to the phase of a clock which is input from the clock input buffer, and
wherein the phase compensating circuit continues the phase compensating operation also in a high impedance state of the clock output buffer.

8. A memory card comprising:
a first external interface terminal;
a second external interface terminal;
an interface controller connected to the first external interface terminal;
a memory device connected to the interface controller; and
an IC card microcomputer connected to the interface controller,
wherein the interface controller controls operation of the memory device and the IC card microcomputer in response to an input from the first external interface terminal,
wherein the second external interface terminal has an IC card terminal directly coupled to a connection line between the interface controller and the IC card microcomputer, and
wherein the interface controller reads predetermined control data from the memory device in response to power-on, sets an output buffer in the interface controller connected to the connection line into a high impedance state in response to a first state of the control data, and sets the output buffer to a state where output operation can be performed in response to a second state of the control data.

9. The memory card according to claim 8, wherein the interface controller reads predetermined control data from the memory device in response to a reset instruction, sets the output buffer to the connection line into a high impedance state in response to the first state of the read control data, and sets the output buffer into a state where output operation can be performed in response to the second state of the control data.

10. A memory card comprising:
a first external interface terminal;
a second external interface terminal;
an interface controller connected to the first external interface terminal;
a memory device connected to the interface controller; and
an IC card microcomputer connected to the interface controller,
wherein the interface controller controls operation of the memory device and the IC card microcomputer in response to an input from the first external interface terminal,
wherein the second external interface terminal has an IC card terminal directly coupled to a connection line between the interface controller and the IC card microcomputer, and
wherein the interface controller sets an output buffer in the interface controller connected to the connection line into a high impedance state in response to a first command supplied from the first external interface terminal, and sets the output buffer into a state where output operation can be performed in response to a second command supplied from the first external interface terminal.
